(19) United States
(12) Patent Application Publication
(10) Pub. No.: US 2018/0198744 A1
(43) Pub. Date: Jul. 12, 2018

(54) SYSTEM AND METHOD FOR SENDING AUTOMATICALLY EXECUTING FUNCTIONS IN A MESSAGE

(71) Applicants: Jeffrey W. ZIGLAR, New York, NY (US); Dierk Van Zandt, Yonkers, NY (US)

(72) Inventors: Jeffrey W. ZIGLAR, New York, NY (US); Dierk Van Zandt, Yonkers, NY (US)

(73) Assignee: Acticon LLC, Sagaponack, NY (US)

(21) Appl. No.: 15/912,943

(22) Filed: Mar. 6, 2018

Related U.S. Application Data
(60) Provisional application No. 62/467,366, filed on Mar. 6, 2017.
(60) Provisional application No. 62/637,522, filed on Mar. 2, 2018.

(51) Int. Cl. H04L 12/58

(52) U.S. Cl. CPC H04L 51/18; H04L 51/08; H04L 51/10

(57) ABSTRACT

Systems and methods are disclosed for a messaging application used to create sequential logic functions and create messages that include sequential logic functions. A method of creating a message comprises drafting a text portion of the message and selecting at least one predefined sequential logic function, transmitting the at least one predefined sequential logic function from a desktop application to a core messaging platform, retrieving computer executable instructions associated with the at least one predefined sequential logic function from a database, and packaging the text portion and the computer executable instructions associated with the at least one predefined sequential logic function as a message to be sent to a receiving device.

### CROSS REFERENCE TO RELATED APPLICATIONS

The present application claims priority to U.S. Provisional Application No. 62/467,366, filed Mar. 6, 2017, and U.S. Provisional Application No. 62/637,522, filed Mar. 2, 2018, the entirety of which are hereby incorporated by reference.

### FIELD OF THE DISCLOSURE

The present disclosure relates generally messaging systems, and more specifically to messaging systems configured to send messages with automatically executing functions.

### BACKGROUND

Messaging systems and messaging applications are ubiquitous in today's modern world. Billions of users engage in messaging on a daily basis. Messaging systems allow communication between users with text, photo, video, other multimedia, and even ideograms commonly referred to as emojis.

In a typical scenario such as that shown in FIG. 1, a user will input a message at a first user device 11. The first user device 11 may be but is not limited to one of a phone, as smart phone, a tablet computer, a computer, or similar device. Upon sending the message, the message is transmitted from the first user device 11 to a network 12. The network 12 may be but is not limited to one of a landline, public telephone network, WiFi, cellular, or Internet-based network. The network 12 processes the message and delivers it to the appropriate recipient(s) at second user device 13. Second user device 11 may be but is not limited to one or more of a phone, as smart phone, a tablet computer, a computer, or similar device.

A typical messaging application provides a user with a keyboard to input standard characters, as illustrated in FIG. 2. FIG. 2 is an illustration of a user device 201 having a graphical user interface 202 with a standard keyboard 203 that allows a user to type a message into a messaging application. In some applications, additional interfaces may be provided that allow a user to add photos, video, other multimedia to the message. In some applications, additional interfaces may be provided that allow a user to include special characters and/or ideograms to the message.

The recipient of a message may be required to take additional actions to receive the full extent of the message. These additional actions can be cumbersome and inefficient. In some situations, these additional actions interfere with a user's messaging experience by requiring one or more clicks that tend to slow down the messaging process. For example, in standard messaging applications when a sender includes a video with a message, the recipient is required to click on the video icon to begin playing the video. If a sender includes a web link with a message, the recipient is required to click on the web link to upload and/or view the associated webpage. If a recipient wishes to delete a message, they are required to make one or more clicks to effect deletion. Still further, in existing messaging applications a user may not be able to ensure that a certain action (e.g. message deletion) will be taken by the recipient.

### SUMMARY

According to an aspect of the present disclosure, a method of creating a message comprises drafting, via a desktop application on a sending device, a text portion of the message; selecting, via the desktop application, at least one predefined sequential logic function to be sent with the text portion of the message; transmitting the at least one predefined sequential logic function from the desktop application to a core messaging platform; retrieving, by the core messaging platform, computer executable instructions associated with the at least one predefined sequential logic function from a database; and packaging the text portion and the computer executable instructions associated with the at least one predefined sequential logic function as a message to be sent to a receiving device.

In some embodiments, the method further comprises sending the message to the receiving device; and executing the computer executable instructions associated with the at least one predefined sequential logic function. In some embodiments the step of executing the computer executable instructions associated with the at least one predefined sequential logic function is performed at a predetermined time interval after display of the text portion of the message on the receiving device.

In some embodiments the step of executing the computer executable instructions associated with the at least one predefined sequential logic function is performed only after receiving separate instructions from the sending device via the core messaging platform to execute the function. In some embodiments the step of selecting at least one predefined sequential logic function further comprises editing at least one parameter of the predefined function. In some embodiments the at least one parameter is one of time interval before executing the sequential logic function, the activation trigger for executing the sequential logic function, file names for sending one or a series of multiple files, playback parameters to trigger/control the activation of a multimedia file, a file deletion request of a single or multiple files, remote control of emoji assets/badge behavior, and request for screen position rendering of non-text messages.

In some embodiments the predefined sequential logic function was uniquely created by a user of a messaging application. In some embodiments the predefined sequential logic was uploaded to a database after creation and made available to other users of the messaging application.

According to another aspect of the present disclosure, a method of messaging between a sending device and a receiving device comprises transmitting a message from the sending device to a web service API, said message containing instructions for executing a function on the receiving device at a predetermined interval after the message is displayed on the receiving device and without action by a user of the receiving device; transferring the message to a core messaging platform; transmitting the message from the core messaging platform to the receiving device; and executing the function on the receiving device at the predetermined interval after the message is displayed on the receiving device and without action by the user of the receiving device.

In some embodiments the method further comprises polling the receiving device for availability and permission to receive the message prior to transmitting the message from the core messaging platform to the receiving device. In some embodiments the step of transmitting the message from the core messaging platform to the receiving device is performed only if the receiving device is available and grants permission to receive the message in response to the polling. In some embodiments permission is granted at the receiving device to receive one or more messages prior to the step of transmitting the message from the sending device to the web service API.

In some embodiments the function is a predefined sequential logic function and wherein said function is selected via a graphical user interface of the sending device. In some embodiments each of the sending device and the receiving device is one of a phone, a smartphone, a tablet computer, or a computer. In some embodiments the instructions for executing a function were written by a user of a messaging application and uploaded to a database in communication with the core messaging platform.

According to yet another aspect of the present disclosure, a computer implemented method for executing a function in a message comprises inputting a message into a sender device; selecting an action icon to be included in the message, the action icon associated with an executable function; sending the message including an action icon from the sender device to a recipient device; displaying the message including an action icon on the recipient device; executing, without additional action by the recipient, the executable function associated with the action icon included with the message.

In some embodiments the executable function associated with the action icon is one or more of the following: deleting the message, commencing a file transfer, opening a webpage, playing a video, displaying a photo, and commencing a download. In some embodiments the action icon included in the message flashes prior to executing the executable function.

In some embodiments the method further comprises selecting a time interval between the step of displaying the message including an action icon on the recipient device and the step of executing, without additional action by the recipient, the executable function associated with the action icon included with the message. In some embodiments the time interval is selected by selecting one of a plurality of action icons that vary only by color.

### BRIEF DESCRIPTION OF THE DRAWINGS

The following will be apparent from elements of the figures, which are provided for illustrative purposes and are not necessarily to scale.

FIG. 1 is a schematic diagram of user devices messaging via a network.

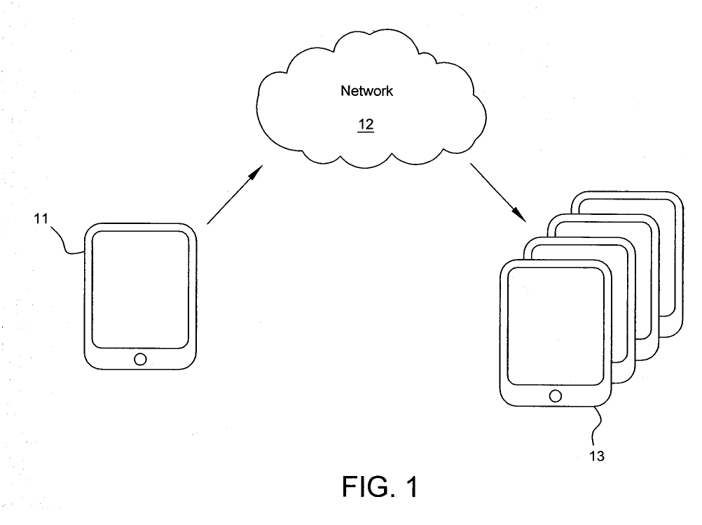

FIG. 2 is a schematic diagram of a graphical user interface of a messaging application in a user device.

FIG. 3 is a schematic diagram of a graphical user interface of a messaging application in a user device in accordance with some embodiments of the present disclosure.

FIG. 4 is a flow diagram of a method in accordance with some embodiments of the present disclosure.

FIG. 5 is an image of an example of the present disclosure in use, in accordance with some embodiments of the present disclosure.

FIG. 6 is a flow diagram of a method in accordance with some embodiments of the present disclosure.

FIG. 7 is a schematic diagram of a communications network in accordance with some embodiments of the present disclosure.

FIG. 8 is a flow diagram of a method of creating a predefined sequential logic function in accordance with some embodiments of the present disclosure.

FIG. 9 is a flow diagram of a method of messaging in accordance with some embodiments of the present disclosure.

FIG. 10 is a block diagram of one example of an architecture of user device 201.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

For the purposes of promoting an understanding of the principles of the disclosure, reference will now be made to a number of illustrative embodiments illustrated in the drawings and specific language will be used to describe the same.

This disclosure presents embodiments to overcome the aforementioned deficiencies in messaging systems and applications. More specifically, the present disclosure is directed to systems and methods for sending automatically executing functionality in a message. The present disclosure is directed to a digital file type that enables a computer implemented method to execute specific actions when sent and received over mobile messaging platforms as a character entered through haptic selection in the messaging field. The file characters execute specifically defined actions when either the sender (once sent) or receiver (once opened or selected manually) transfer the file as a character on a mobile messaging platform.

The present disclosure is additionally directed to systems and methods of creating sequential logic functions for use in a messaging application. Sequential logic functions are portions of messages that are executed in sequential fashion with the display of a message on a user device. For example, a sequential logic function may be executed either antecedent to or following from the display of the text of a message on a user device. A user may create a sequential logic function that is then validated by the messaging platform and added to a database for future use and retrieval. The new sequential logic function may be made generally available to users of the messaging application or may be made available only to a subset of users.

The present disclosure is further directed to systems and methods of including a predefined sequential logic function in a message. A user may input a text portion of a message and select a predefined sequential logic function. The message is transmitted via a core communication server to a receiving device, and the sequential logic function is executed according to the predefined parameters of the function. The function may include granting permission to the sending user to perform actions on the receiving device and/or share screens between the sending device and receiving device.

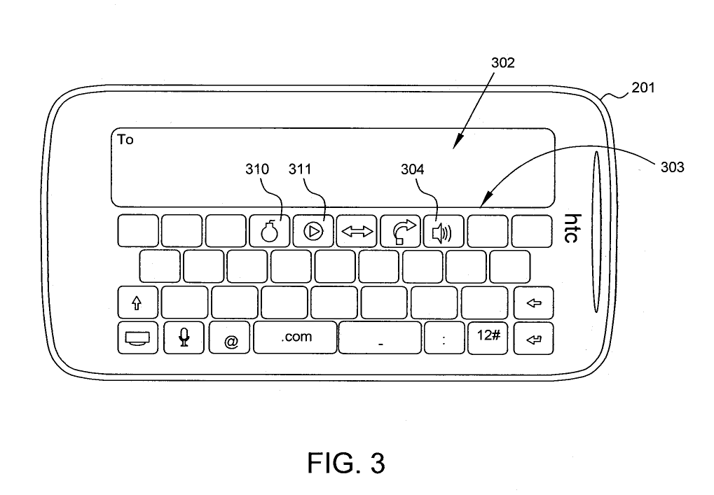

FIG. 3 is a schematic diagram of a graphical user interface 302 of a user device 201 running a messaging application in accordance with some embodiments of the present invention. FIG. 3 illustrates a user input or keyboard 303 of the graphical user interface 302 configured to allow a user to select from a plurality of action icons 304, 310, and 311 for inclusion in the message. Each of the action icons 304, 310, and 311 are associated with a pre-defined set of executable instructions that perform a function. For example, action icon 310 is associated with a pre-defined set of executable instructions that will delete, without further action from a recipient, a message upon displaying the message at the recipient user device for a pre-determined or user-specified period of time. As another example, action icon 311 is associated with a pre-defined set of executable instructions that will play, without further action from a recipient, a video upon displaying the message at the recipient user device for a pre-determined or user-specified period of time.

In some embodiments, the action icon 304 may visually indicate the action to be taken. For example, as illustrated in FIG. 3, an action icon 310 of a bomb with a fuse may be used to indicate that a message will be deleted at a set time interval after being first displayed on a recipient user device.

Each action icon 304 is associated with a set of executable instructions for performing a function on the recipient user device. Such functions include but are by no means limited to: deleting the message, commencing a file transfer, opening a webpage, playing a video, displaying a photo, transferring a calendar appointment file or meeting notice, transferring one or more contact information files, posting to social media, and commencing a download. In some embodiments, the function to be performed is a multi-step process. For example, in some embodiments the function associated with an action icon 304 is the opening of a webpage and the playing of a video accessible through that webpage. In some embodiments the function associated with an action icon 304 is the transferring and/or posting of a file or message to social media.

Each action icon 304 may be additionally associated with an activation trigger. For example, in some embodiments an action icon may activate—which is to say execute the executable instructions—after a set time interval has passed with the message displayed on the recipient user device. Additional activation triggers may include a set time interval since the message was sent from the sender user device, the message was received at the recipient user device, the message was first displayed on the recipient user device, or the message was opened by the recipient on the recipient user device.

According to various embodiments, user device 201 includes any mobile device capable of transmitting and receiving wireless signals. Examples of mobile instruments include, but are not limited to, mobile or cellular phones, personal digital assistants (“PDAs”), laptop computers, tablet computers, music players, and e-readers, to name a few possible devices.

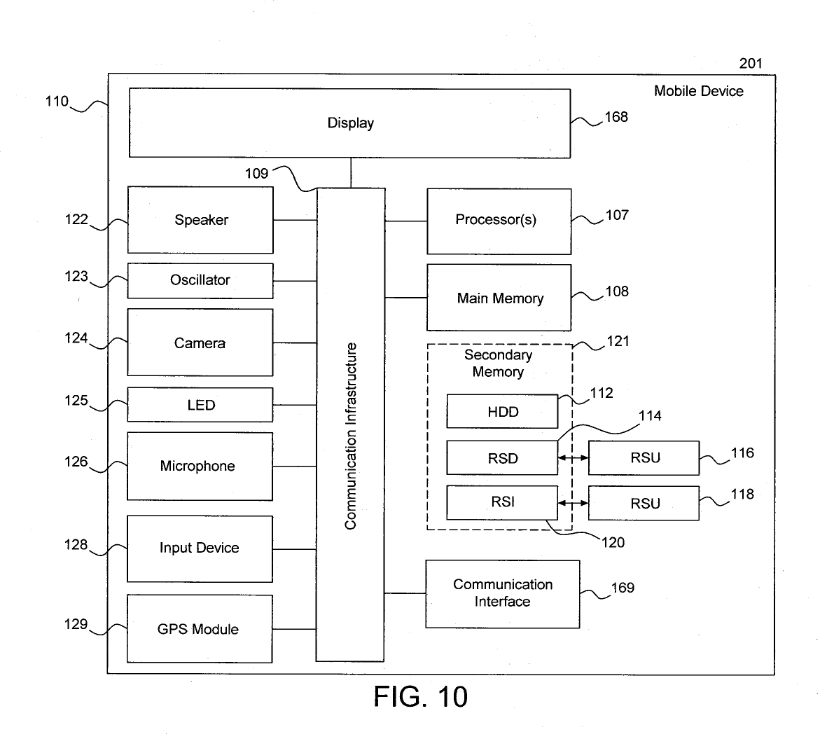

FIG. 10 is a block diagram of one example of an architecture of user device 201. According to some embodiments, user device 201 includes one or more processors. Processor(s) may be any central processing unit (“CPU”), microprocessor, micro-controller, or computational device or circuit for executing instructions. Processor(s) are connected to a communication infrastructure 109 (e.g., a communications bus, cross-over bar, or network). Various software embodiments are described in terms of this exemplary user device 201. After reading this description, it will be apparent to one of ordinary skill in the art how to implement the method using user devices 201 that include other systems or architectures. One of ordinary skill in the art will understand that computers may have a similar and/or identical architecture as that of user devices 201. Put another way, computers can include some, all, or additional functional components as those of the user device 201 illustrated in FIGS. 3 and 10.

User device 201 includes a display 168 that displays graphics, video, text, and other data received from the communication infrastructure 109 (or from a frame buffer not shown) to a user (e.g., a subscriber, commercial user, back-end user, or other user). Examples of such displays 168 include, but are not limited to, LCD screens, OLED display, capacitive touch screen, and a plasma display, to list only a few possible displays. User device 201 also includes a main memory 108, such as a random access (“RAM”) memory, and may also include a secondary memory 110. Secondary memory 110 may include a more persistent memory such as, for example, a hard disk drive (“HDD”) 112 and/or removable storage drive (“RSD”) 114, representing a magnetic tape drive, an optical disk drive, solid state drive (“SSD”), or the like. In some embodiments, removable storage drive 114 reads from and/or writes to a removable storage unit (“RSU”) 116 in a manner that is understood by one of ordinary skill in the art. Removable storage unit 116 represents a magnetic tape, optical disk, or the like, which may be read by and written to by removable storage drive 114. As will be understood by one of ordinary skill in the art, the removable storage unit 116 may include a tangible and non-transient machine readable storage medium having stored therein computer software and/or data.

In some embodiments, secondary memory 110 may include other devices for allowing computer programs or other instructions to be loaded into user device 201. Such devices may include, for example, a removable storage unit (“RSU”) 118 and a corresponding interface (“RSI”) 120. Examples of such units 118 and interfaces 120 may include a removable memory chip (such as an erasable programmable read only memory (“EPROM”)), programmable read only memory (“PROM”)), secure digital (“SD”) card and associated socket, and other removable storage units 118 and interfaces 120, which allow software and data to be transferred from the removable storage unit 118 to user device 201.

User device 201 may also include a speaker 122, an oscillator 123, a camera 124, a light emitting diode (“LED”) 125, a microphone 126, an input device 128, and a global positioning system (“GPS”) module 129. Examples of input device 128 include, but are not limited to, a keyboard, buttons, a trackball, or any other interface or device through a user may input data. In some embodiment, input device 128 and display 168 are integrated into the same device. For example, display 168 and input device 128 may be touchscreen through which a user uses a finger, pen, and/or stylus to input data into user device 201.

User device 201 also includes one or more communication interfaces 169, which allows software and data to be transferred between user device 201 and external devices such as, for example, another user device 201, a computer, and other devices that may be locally or remotely connected to user device 201. Examples of the one or more communication interfaces 169 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. The one or more communication interfaces 169 may also include a wireless interface configured for short-range communication, such as near field communication (“NFC”), Bluetooth, or other interface for communication via another wireless communication protocol. As briefly noted above, one of ordinary skill in the art will understand that computers may include some or all components of user device 201.

Software and data transferred via the one or more communications interfaces 169 are in the form of signals, which may be electronic, electromagnetic, optical, or other signals capable of being received by communications interfaces 169. These signals are provided to communications interface 169 via a communications path or channel. The channel may be implemented using wire or cable, fiber optics, a telephone line, a cellular link, a radio frequency (“RF”) link, or other communication channels.

In this document, the terms “non-transitory computer program medium” and “non-transitory computer readable medium” refer to media such as removable storage units 116, 118, or a hard disk installed in hard disk drive 112. These computer program products provide software to user device 201. Computer programs (also referred to as “computer control logic”) may be stored in main memory 108 and/or secondary memory 110. Computer programs may also be received via the one or more communications interfaces 169. Such computer programs, when executed by a processor(s) 107, enable the user device 201 to perform the features of the method discussed herein.

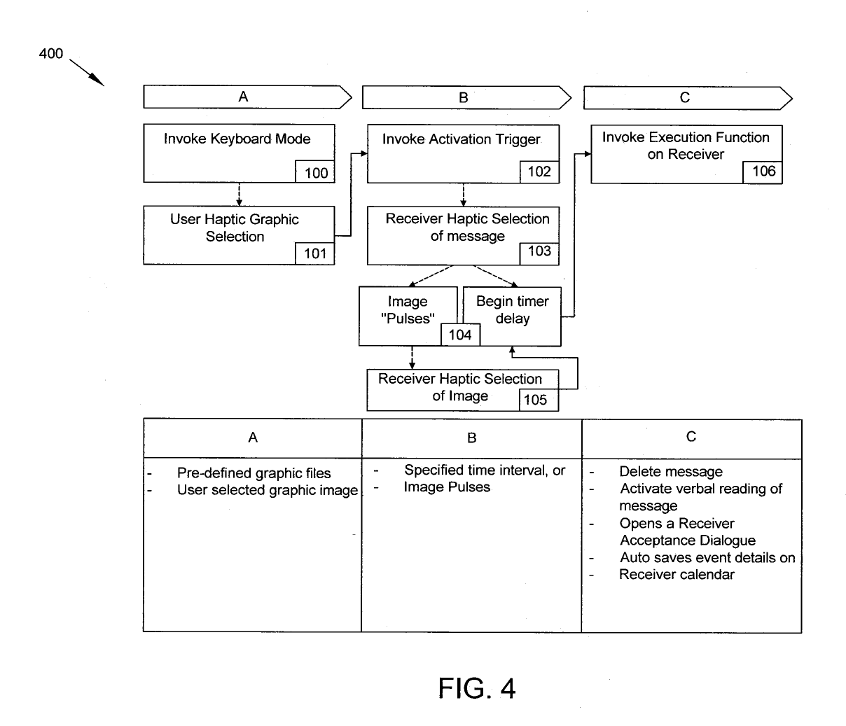

FIG. 4 provides a flow diagram of a method in accordance with some aspects of the present disclosure. The method 400 generally proceeds from column A to column B to column C. The method 400 begins at step 100, where numerous action icons are accessed by the user through a keyboard sub-page that is downloaded onto the mobile device as a messaging application. When the user is operating in a field that requires written text, the keyboard is activated, allowing the user to type standard text, emoticons or action icons through haptic selection. At step 101, the user, through haptic selection, inserts an action icon into the message field.

The method 400 proceeds to Column B, where, at step 102, the activation trigger of the selected action icon is invoked. In some embodiments, the activation trigger is invoked upon sender selecting the “Send” button on the sender user device. In other embodiments, for example, the activation trigger may be invoked upon display of the message on the recipient user device. In some embodiments at step 103 the recipient opens (i.e. displays) the message containing the selected action icon, which completes the activation trigger sub-routine. In some embodiments, at step 104 the action icon may flash or pulse to indicate the commencement of the delay timer. In some embodiments the action icon will either invoke a timer countdown, or pulse visually, indicating that the recipient can use haptic touch to initiate the defined action or may wait until the end of the delay period and the action will be taken without further recipient action. In some embodiments, method 400 proceeds to optional step 105, where if the action icon was in pulsing mode, and the recipient initiated the action icon through haptic selection, then the timer is started with a zero second delay.

Method 400 generally proceeds then to Column C, where at step 106 the action icon executes its programmed action, to perform one or multiple actions automatically on the recipient user device. The method 400 may proceed to step 106 without action by the recipient. In other words, in some embodiments, once the message is displayed at the recipient user device, the recipient need not take any further action and the action icon will execute the associated executable instructions and perform the associated function.

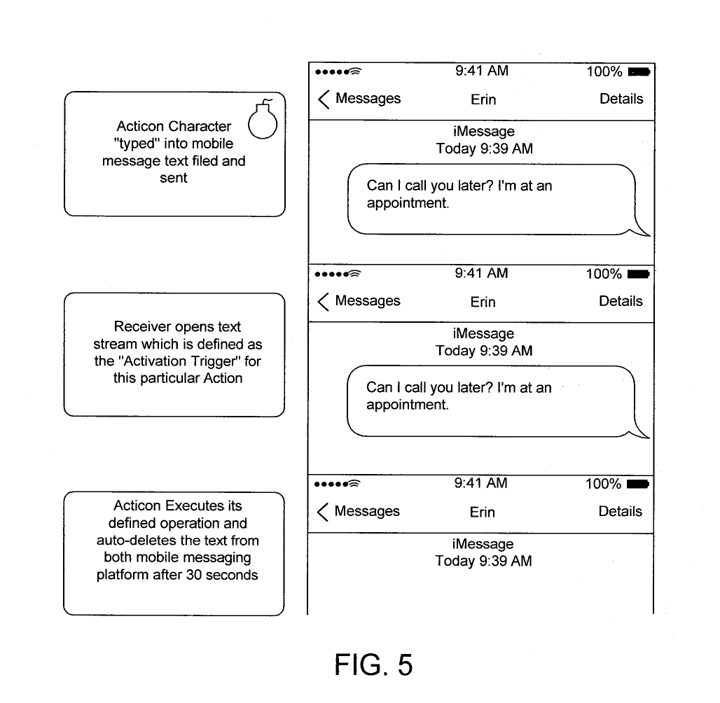

FIG. 5 provides an image of one example of the systems and methods of the present disclosure. In the example of FIG. 5, a sender has sent a message that includes an action icon associated with the functionality that deletes a messages after a predetermined interval. In this example, the action icon is represented as a bomb with a fuse, and that action icon was typed into the message by the sender. The message is displayed on the recipient user device, and the bomb with fuse icon is displayed with the message. The display of the message on the recipient user device is the activation trigger for the action icon in this example. After a set interval from the start of displaying the message, the message is deleted. In the provided example, the set interval is 30 seconds.

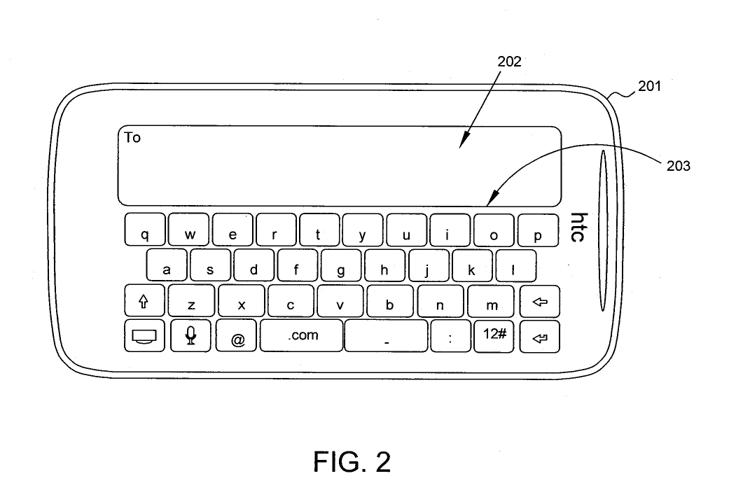

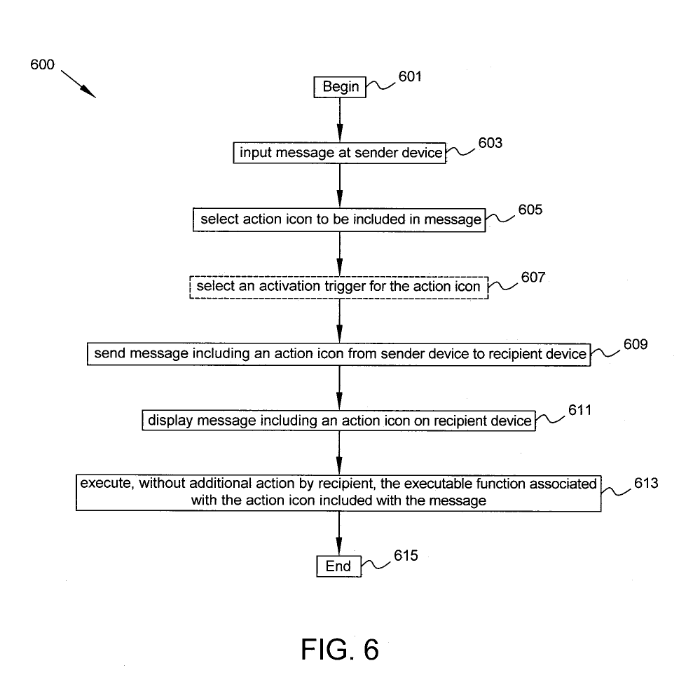

FIG. 6 is a flow diagram of a method 600 in accordance with some embodiments of the present disclosure. Method 600 begins at step 601 and proceeds to step 603, where a user (sender) inputs a message at a user device. The user device used by sender in method 600 may be user device 201 as described above with reference to FIGS. 2 and 3. At step 605, the user (sender) selects an action icon 304 to be included in the message. Action icons 304 may be as described above. In particular, each of the plurality of action icons 304 available for user (sender) selection will have an associated one or more actions and/or functions that will be carried out on the message recipient's user device once the action icon's activation trigger is triggered.

At optional step 607, indicated in dashed outline, according to some embodiments a user (sender) may select an activation trigger for the action icon 304. This step is optional as the activation triggers may be pre-programmed or pre-determined for each of the action icons 304 available for selection. In some embodiments each action icon 304 available for selection has the same activation trigger. In other embodiments, more than one activation trigger may be used for the plurality of action icons 304. In still further embodiments, the activation triggers may be selectable or customizable by the user (sender) at step 607.

At step 609 the message including an action icon 304 is sent from the sender user device to the recipient user device. The recipient user device used by sender in method 600 may be user device 201 as described above with reference to FIGS. 2 and 3. At step 611 the message is displayed on the recipient user device.

At step 613, without any additional action being taken by the recipient, the one or more actions and/or functions associated with the selected action icon 304 are executed. The method 600 ends at step 615.

In some embodiments, the present disclosure is directed to a digital file type that enables a computer implemented method to execute specific actions when sent and received over mobile messaging platforms. A digital file of the disclosed digital file type may be shared and activated to perform its defined execution between users when included in the message field of a mobile message. The file script of the disclosed digital file type has three key distinguishing components: i) graphic image rendering ii) activation trigger and iii) execution functionality.

In some embodiments, the action icon may be input and displayed in the message as typed by the sender, but may not be displayed to the recipient on the recipient user device.

In some embodiments, one or more of the following may be customized by the user via the graphical user interface of the disclosed messaging application: the specific activation trigger for the action icon, the time interval between the activation trigger and the executing of the associated function, and the functionality associated with an action icon.

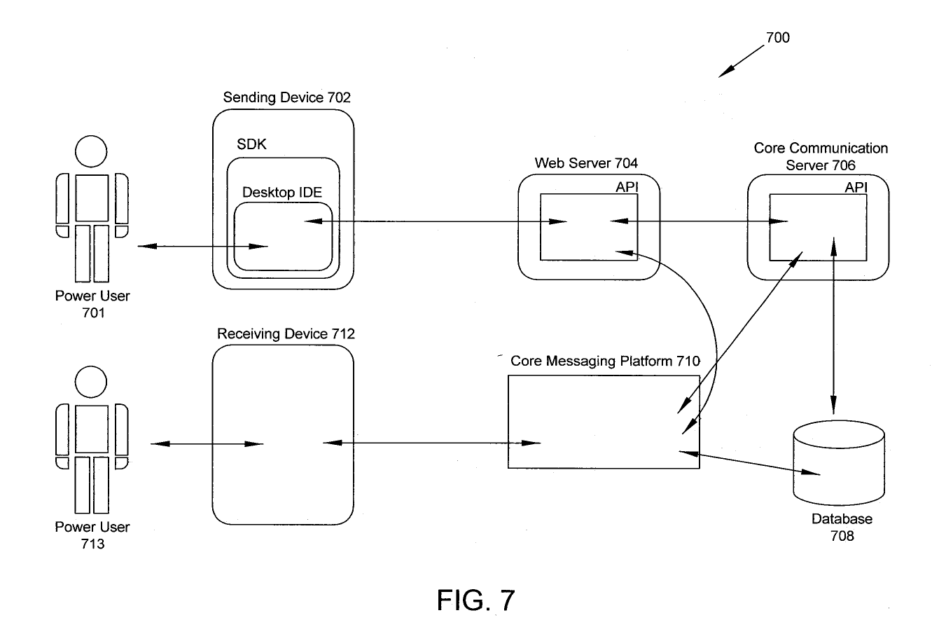

FIG. 7 is a schematic diagram of a communication network 700. The various components of the communication network 700 are in communication with each other as indicated by the arrows of FIG. 7.

A power user 701 operates a sending device 702 via a graphical user interface and/or input and output devices. Power user 701 may also be referred to as a sending user.

The sending device 702 includes a software development kit (SDK) application that operates on the desktop integrated development environment (IDE). The IDE is used to gather input from and graphically demonstrate to the power user 701 regarding creation and editing of a message and associated functionality. The IDE may further be used to gather input from and graphically demonstrate to the power user 701 the creation, definition, and editing of a sequential logic function.

The sending device 702 is in communication with a web server 704 having an API (Application Programming Interface). The web service API may be specific to the messaging application displayed in the desktop IDE and used by power user 701.

Using the desktop IDE and the software development kit, power user 701 creates, defines, and edits both the text portion of a message and associated instructions for at least one predefined sequential logic function. In some embodiments, power user 701 may also create, define, and edit computer executable instructions associated with the at least one sequential logic function.

The API of web server 704 validates the text portion of a message as well as the associated at least one predefined sequential logic function and may also validate the computer executable instructions of the at least one predefined sequential logic function.

Web server 704 is in communication with a core communication server 706. Core communication service 706 may also include an API. Core communications server 706 is in communication with a database 708 and a core messaging platform 710.

Core communication server 706 may include or otherwise be in communication with at least one Custom File Control Input/Output Library. This library provides secure mapping of permissions in the messaging application (for example, indicating whether a receiving user 713 has granted permission to generally receive messages through the messaging application or to receive messages from a specific power user 701 through the messaging application). The Custom File Control Input/Output Library additionally facilitates file-over-messaging protocols in the messaging application.

Core communication server 706 may further include or otherwise be in communication with an Extended Remote Access NIO Library. This library provides an API template for definition by the power user 701, and allows for customized remote method invocation and network optimized remote control.

In some embodiments, computer executable instructions for a sequential logic function are transmitted from the web server 704 to the core communications server 706. The court communication server 706 interfaces with database 708 to store the computer executable instructions.

In some embodiments, messages that include a text portion and at least one predefined sequential logic function are transmitted from the web server 704 to the core communications server 706. The court communication server 706 interfaces with database 708 to store the message.

Web server 704 may further be in communication with core messaging platform 710. In some embodiments the API of web server 704 transmits a client request to the core messaging platform 710. The core messaging platform 710 then retrieves a message and/or computer executable instructions stored in database 708 and processes that message for execution.

Core messaging platform 710 is in communication with receiving device 712 and may poll and/or transmit messages to and from receiving device 712. Receiving user 713 interacts with receiving device 712 via a graphical user interface and/or input and output devices.

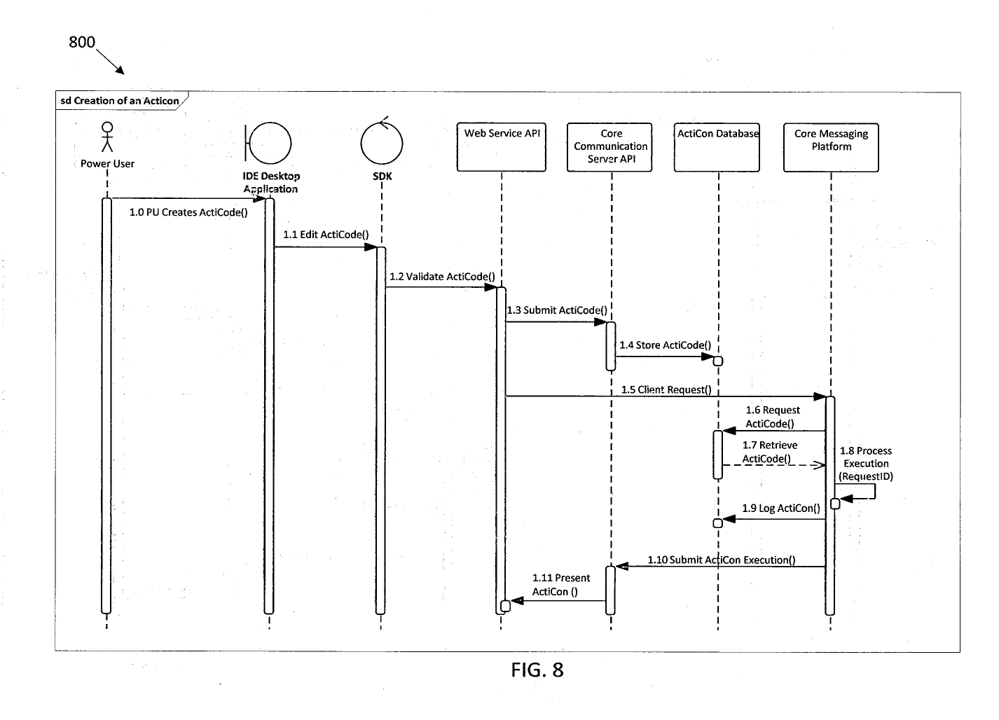

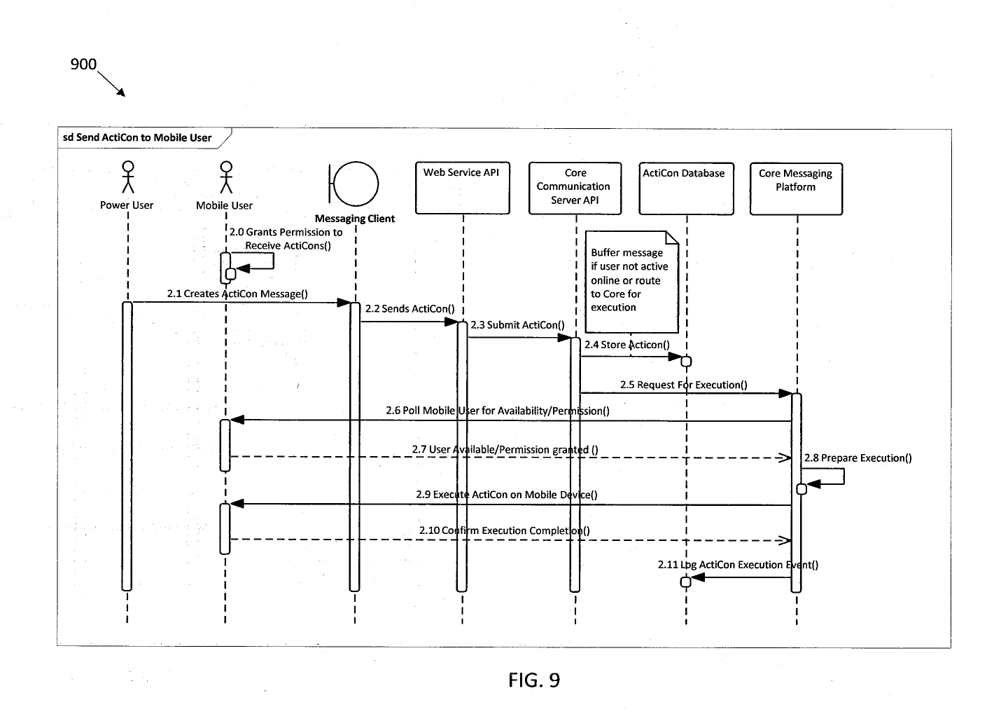

According to some aspects of the present disclosure, an application is provided to allow a user, such as power user 701, to define new sequential logic functions that are added to a function database referenced by the application. Users, such as but not limited to power user 701, are subsequently able to reference and utilize these user-defined sequential logic functions when messaging. FIGS. 8 and 9 describe such embodiments.

FIG. 8 is a flow diagram of a method 800 of creating a sequential logic function. Method 800 uses the communication network 700 described above with reference to FIG. 7.

At step 1.0 and 1.1, the power user 701 creates and edits a sequential logic function using the desktop IDE and software development kit running on sending device 702. The desktop IDE and software development kit provide a graphical user interface on sending device 702 that allows the power user 701 to create computer code, or computer executable instructions, that will execute a sequential logic function.

The sequential logic function may be referred to as an action code or “ActiCode” as shown in FIG. 8. A sequential logic function is any functionality sent with or referenced by a message that is to be executed sequential to the display of the text portion of a message on a user device. That is to say a sequential logic function is typically designed to be executed after a predetermined time interval from the display of the text portion of a message. Of note, the text portion is not strictly limited to text characters but may include graphics, emojis, images, and the like. The text portion is used to refer herein to that part of a message that is not the sequential logic function.

When creating the sequential logic function, the power user 701 may define (or may be prompted to define by the software development kit) not only the graphics associated with the function but also key parameters of the function. Those parameters may include a trigger (i.e. display of the message, clicking on a link, etc), a time delay interval (the time between display of the message and execution of the sequential logic function), a time interval (the duration of executing the sequential logic function), volume, file names for sending one or a series of multiple files (i.e. video, sounds, animations, badges, images, etc.), playback parameters to trigger/control the activation of a multimedia file, a file deletion request of a single or multiple files, remote control of emoji assets/badge behavior, and a request for screen position rendering of non-text (vector image) messages.

As an example, power user 701 may create a sequential logic function directed to the deletion of a message. The text portion of the message is received and displayed at receiving device 712. After a predefined time interval of displaying the text portion of the message on the receiving device 712, a sequential logic function is executed to erase the message. In this example, erasing the message may take the form of the text portion of the message being overwhelmed (i.e. covered by) the graphical form of a large ocean wave. The text portion may be visually washed away, similar to words written in sand being washed away by an ocean wave on the beach. Power user 701 codes this graphic as a new sequential logic function or ActiCode using the desktop IDE and software development kit loaded and running on sending device 702.

The new sequential logic function is then transmitted from the sending device 702 to web server 704 so that the new sequential logic function may be validated. This is illustrated as step 1.2. On the client side, software development kit performs a syntax validation of the code submitted from the desktop IDE against the platform data dictionary. The validation consists primarily of ensuring that the class names, method signatures and variable types are known to the platform, as defined in the software data kit data dictionary, and correspond to the API supported by the platform

Once validation is complete, at step 1.3 the web server 704 may forward the new sequential logic function to the core communications server 706. Core communication server 706 will interface with database 708 to store the new sequential logic function in an application database that allows the new sequential logic function to be retrieved by other users of the messaging application. Those other users may include all users of the messaging application or may only comprise a subset of those users. For example, the database 708 may only allow retrieval of a new sequential logic function created by power user 701 by those other users of the messaging application in the power user's network or in a group defined by power user 701. This allows power user 701 to set limits or otherwise define which other users of the messaging application may share in the new sequential logic function created by power user 701.

The new sequential logic function created by power user 701 is now available for use in the messaging application. At a later time, and as further explained with reference to FIG. 9 below, the power user 701 may send a message that includes a reference to the newly defined sequential logic function. A client request is sent from the API of the web server 704 at step 1.5 to the core messaging platform 710.

Upon receipt of a client request that references the newly defined sequential logic function, the core messaging platform 710 retrieves the referenced sequential logic function from database 708. The retrieval is illustrated at steps 1.6 and 1.7, wherein the messaging platform 710 requests and retrieves the sequential logic function.

The core messaging platform 710 then processes the sequential logic function for execution, which may in some embodiments include identifying a request ID. A log entry is made at step 1.9 in database 708 to indicate the use of the sequential logic function.

Core messaging platform 710 then submits the sequential logic function for execution to the API of core communication server 706 at step 1.10. At step 1.11 the core communications server 706 forwards the sequential logic function to the API of web server 704.

Additional details regarding the drafting and sending of a message including the newly defined the sequential logic function are provided below. In summary, FIG. 8 discloses a method by which users of a messaging application are able to create sequential logic functions or “ActiCodes” that may then be accessible to others on the messaging application. By allowing users of the messaging application to code for their desired sequential logic functions, the method of FIG. 8 provide tremendous flexibility to users to creatively engage with the messaging application and to define unique message functions. The sequential logic functions may include functions for message delivery, convene emotions and humor, message deletion, social media interactions, web content interactions, and personalized avatars or other animations.

FIG. 9 is a flow diagram of a method 900 of creating a message having a sequential logic function. Method 900 uses the communication network 700 described above with reference to FIG. 7 and may also use the sequential logic function defined using the method 800 described above with reference to FIG. 8.

At steps 2.1 and 2.2, a power user 701 interacts with the desktop IDE and/or messaging client to create a message. The message comprises a text portion and at least one predefined sequential logic function. Of note, the text portion is not strictly limited to text characters but may include graphics, emojis, images, and the like. The text portion is used to refer herein to that part of a message that is not the sequential logic function. The message may be referred to, as in FIG. 9, as an active icon or “ActiCon.”

The desktop IDE is running over the software development kit on sending device 702 and allows the power user 701 to create, define, and/or edit the message and to select the at least one predefined sequential logic function.

In some embodiments power user 701 creates a message using standard characters and functional icons. For example, the graphical user interface of the sending device 702 may display to the user a keyboard for inputting standard characters as the text portion of a message, as well as functional icons associated with predefined sequential logic functions. The icons shown in FIG. 3 are illustrative but not limiting. Each of these icons allows the power user 701 to select predefined functionality that will be executed at the receiving device 712 in accordance with the predefined sequential logic functions.

By way of example, a power user 701 may create a message containing a text portion of “Check this out!” and containing the auto play icon 311 shown in FIG. 3. Power user 701 may then also include a link to web content in video format. Action icon 311 is associated with a pre-defined set of executable instructions that will play, without further action from a recipient, a video upon displaying the message at the recipient user device for a pre-determined or user-specified period of time.

In this example, once the message is received and displayed at the receiving device 712, and after a predetermined interval of time has passed from displaying the message, the auto play functionality will execute on the receiving device 712 such that the web content video is displayed on the receiving device 712. The auto play functionality may include additional graphics that transition between displaying the message and displaying the video content on the graphical user interface of receiving device 712.

At step 2.2, the desktop IDE and/or messaging client of the sending device transmits the message to web server 704. The API on web server 704 validates the message. On the server side, the API of web server 704 performs another syntax validation of the code submitted for execution, in addition to the client side validation performed by the software development kit. The validation consists of ensuring that the class names, method signatures, and variable types are known to the platform, as defined in the server-side data dictionary, and correspond to the API supported by the platform.

At step 2.3 the message including a sequential logic function is submitted from the API of web server 704 to the API of core communications server 706. Core communication server 706 may then store the message including a sequential logic function at the database 708, and/or may buffer the message until an indication is received that the receiving user 713 is available to receive the message. The storage of the message is indicated at step 2.4.

At step 2.5 the API of core communication server 706 sends a request for execution to the core messaging platform 710. The core messaging platform 710 is primarily responsible for interaction with the receiving device 712 for delivery and execution of the message.

Call messaging platform 710 may, in some embodiments, poll the receiving device 712 to verify whether the receiving device 712 is available and/or whether the receiving user 713 has given permission through the messaging application to receive messages including sequential logic functions. The poll may take the form of a message sent from the core messaging platform 710 to the receiving device 712 to ascertain the availability of the device and/or the permission settings in the messaging application. At step 1.7 a message may be returned from the receiving device 712 to the core messaging platform 710 indicating the availability and permission settings.

Receiving user 713 may have previously granted permission to receive messages having sequential logic functions as indicated at step 2.0 of FIG. 9. Such permission may have been granted using a graphical user interface of the messaging application on the receiving device 712.

If the receiving device 712 is available and the permission settings indicate that the receiving device 712 may receive messages including sequential logic functions via the messaging application, the core messaging platform 710 will prepare execution of the message. Preparation at step 2.8 of FIG. 9 may include steps 1.6 and 1.7 described with reference to FIG. 8 above, whereby the core messaging platform 710 retrieves the computer executable instructions associated with the sequential logic function from database 708.

At step 1.9 the core messaging platform 710 sends the message and computer executable instructions for the sequential logic function to the receiving device 712. The text portion of the message is then displayed via the messaging application on receiving device 712 and, after the predetermined time interval has elapsed following display of the text portion, the sequential logic function is executed.

Once the sequential logic function is executed, the receiving device 712 confirms this execution completion to the core messaging platform 710. At step 1.11 core messaging platform 710 logs the execution event at database 708 to conclude method 900.

As an example of method 900 in action, a power user 701 may create a message at step 1.1. The text portion of the message may include the standard character word “Congratulations!” and an emoji of two hands clapping. The power user 701 may additionally add a predefined sequential logic function of audio of hands clapping and people cheering.

The power user 701 may set the time delay interval for execution of the sequential logic function at one second. The power user may further set a time interval of execution, for example at three seconds. These intervals indicate that the function will begin executing 1 second following the display of the text portion of the message and will execute for 3 seconds.

The message that includes the text portion in the sequential logic function and defined parameters from the power user 701 is sent from the sending device 702 to the API of Web server 704. The message is then submitted to the API of the court communication server 706, stored in a database 708, and forwarded to the core messaging platform 710 for execution.

Core messaging platform 710 then polls the receiving device 712 for availability and permission to receive such a message through the messaging application. Once availability and permission are confirmed with the receiving device 712, the core messaging platform 710 will send the message to receiving device 712. Upon receipt, the message will be displayed at the receiving device 712 and, after the time delay interval of one second has elapsed the sequential logic function will execute such that audio is played of hands clapping and people cheering. The audio plays for the second time interval defined by the power user 701 of three seconds. In other embodiments, the second time interval is pre-defined in the sequential logic function.

Following display of the message and execution of the sequential logic function, the receiving device 712 confirms execution to the core managing platform 710 and the core messaging platform 710 logs the execution event in database 708.

Although the above embodiments are described as having sequential logic functions that are executed after a time interval from display of a message, in some embodiments of the present disclosure the sequential logic function is executed in advance of the display of the message at receiving device 712. Thus the present disclosure additionally contemplates the use of sequential logic functions to graphically deliver messages.

For example, a sequential logic function may be executed such that a graphic of an airplane passes across the screen of the receiving device 712 when the message is received and an envelope is graphically ‘dropped’ from the airplane. The graphical display is completed when the envelope reaches the bottom of the screen at which point the message is displayed on receiving device 712. Thus a sequential logic function may execute in advance of the message display, or simultaneous with the message display, or following the message display.

The present disclosure additionally provides a method wherein the sequential logic function does not automatically execute upon the elapsing of a time delay interval, but rather executes upon a second set of instructions from the sending device. In such embodiments, the method 900 described above is modified such that the message is delivered to the receiving device 712 but the sequential logic function is not immediately executed and is not executed after a time delay interval. Rather, upon receipt of the message at receiving device 712, the core messaging platform 710 transmits a notice to the sending device 702 indicating that the message was delivered and the sequential logic function is ready to execute. The power user 701 is then able, via a graphical user interface at the sending device 702, to independently instruct the execution of the sequential logic function on the receiving device 712.

The present disclosure can additionally be executed as a sequential logic function that allows the sharing of screens among the sending device 702 and receiving device 712. Thus, when executed the sequential logic function may—where permission is granted by one or both devices—allow for the content of the graphical user display of the sending device 702 to be displayed on the graphical user display of the receiving device 712, or vice versa.

The present disclosure therefore provides systems and methods wherein a messaging application is used to both create sequential logic functions and create messages that include sequential logic functions. The messaging application provides a community for creating and sharing sequential logic functions among users, and creatively developing new, unique functions. The present disclosure contemplates that a user will program computer executable instructions for a unique sequential logic function, will validate and upload those instructions to a database associated with the messaging application, and then will use those instructions in a message via the messaging application. The message will include both a text portion and the sequential logic function, which will be executed at a time and in a manner defined by the user.

The present disclosure provides many advantages over previous systems and methods of messaging between user devices. Most notably, the present disclosure provides systems and methods of messaging that reduce the number of user actions required, thus making for a more streamlined and enjoyable messaging experience. The present disclosure reduces or eliminates the extra clicks, selections, or other actions required by the recipient of a message in order to fully communicate the entirety of the message. Further, the present disclosure in some embodiments will allow sender of the message to ensure that certain actions are taken once the message is displayed at the recipient user device, such as deleting the message.

The usage of the present disclosure is advantageous in that it i) includes auto-execution of actions associated with a graphical digital file included in a mobile message, ii) is activated upon sending or receiving the mobile message without manual user activation and iii) provides series of specific action steps that are not otherwise combined in prior art messaging systems and applications.

Although examples are illustrated and described herein, embodiments are nevertheless not limited to the details shown, since various modifications and structural changes may be made therein by those of ordinary skill within the scope and range of equivalents of the claims.

What is claimed is:

1. A method of creating a message, comprising:
drafting, via a desktop application on a sending device, a text portion of the message;
selecting, via the desktop application, at least one predefined sequential logic function to be sent with the text portion of the message;
transmitting the at least one predefined sequential logic function from the desktop application to a core messaging platform;
retrieving, by the core messaging platform, computer executable instructions associated with the at least one predefined sequential logic function from a database; and
packaging the text portion and the computer executable instructions associated with the at least one predefined sequential logic function as a message to be sent to a receiving device.

2. The method of claim 1 further comprising:
sending the message to the receiving device; and
executing the computer executable instructions associated with the at least one predefined sequential logic function.

3. The method of claim 2 wherein the step of executing the computer executable instructions associated with the at least one predefined sequential logic function is performed at a predetermined time interval after display of the text portion of the message on the receiving device.

4. The method of claim 2, wherein the step of executing the computer executable instructions associated with the at least one predefined sequential logic function is performed only after receiving separate instructions from the sending device via the core messaging platform to execute the function.

5. The method of claim 1 wherein the step of selecting at least one predefined sequential logic function further comprises editing at least one parameter of the predefined function.

6. The method of claim 5 wherein the at least one parameter is one of time interval before executing the sequential logic function, the activation trigger for executing the sequential logic function, file names for sending one or a series of multiple files, playback parameters to trigger/control the activation of a multimedia file, a file deletion request of a single or multiple files, remote control of emoji assets/badge behavior, and request for screen position rendering of non-text messages.

7. The method of claim 1 wherein the predefined sequential logic function was uniquely created by a user of a messaging application.

8. The method of claim 7 wherein the predefined sequential logic was uploaded to a database after creation and made available to other users of the messaging application.

9. A method of messaging between a sending device and a receiving device, the method comprising:
transmitting a message from the sending device to a web service API, said message containing instructions for executing a function on the receiving device at a predetermined interval after the message is displayed on the receiving device and without action by a user of the receiving device;
transferring the message to a core messaging platform;
transmitting the message from the core messaging platform to the receiving device; and
executing the function on the receiving device at the predetermined interval after the message is displayed on the receiving device and without action by the user of the receiving device.

10. The method of claim 9 further comprising:
polling the receiving device for availability and permission to receive the message prior to transmitting the message from the core messaging platform to the receiving device.

11. The method of claim 10 wherein the step of transmitting the message from the core messaging platform to the receiving device is performed only if the receiving device is available and grants permission to receive the message in response to the polling.

12. The method of claim 11 wherein permission is granted at the receiving device to receive one or more messages prior to the step of transmitting the message from the sending device to the web service API.

13. The method of claim 9, wherein the function is a predefined sequential logic function and wherein said function is selected via a graphical user interface of the sending device.

14. The method of claim 9 wherein each of the sending device and the receiving device is one of a phone, a smartphone, a tablet computer, or a computer.

15. The method of claim 9 wherein the instructions for executing a function were written by a user of a messaging application and uploaded to a database in communication with the core messaging platform.

16. A computer implemented method for executing a function in a message comprising:
inputting a message into a sender device;
selecting an action icon to be included in the message, the action icon associated with an executable function;
sending the message including an action icon from the sender device to a recipient device;
displaying the message including an action icon on the recipient device; and
executing, without additional action by the recipient, the executable function associated with the action icon included with the message.

17. The method of claim 16 wherein the executable function associated with the action icon is one or more of the following: deleting the message, commencing a file transfer, opening a webpage, playing a video, displaying a photo, and commencing a download.

18. The method of claim 17 wherein the action icon included in the message flashes prior to executing the executable function.

19. The method of claim 16, further comprising: selecting a time interval between the step of displaying the message including an action icon on the recipient device and the step of executing, without additional action by the recipient, the executable function associated with the action icon included with the message.

20. The method of claim 19 wherein the time interval is selected by selecting one of a plurality of action icons that vary only by color.
